(19) United States
(12) Patent Application Publication
(10) Pub. No.: US 2026/0332864 A1
(43) Pub. Date: Oct. 22, 2026

(54) CAMERA FOR VEHICLE AND VEHICLE

(71) Applicant: LG INNOTEK CO., LTD., Seoul (KR)

(72) Inventor: Min Woo LEE, Seoul (KR)

(73) Assignee: LG INNOTEK CO., LTD., Seoul (KR)

(21) Appl. No.: 19/114,045

(22) PCT Filed: Sep. 25, 2023
(86) PCT No.: PCT/KR2023/014716

§ 371 Date: Mar. 21, 2025

(30) Foreign Application Priority Data
Sep. 30, 2022 (KR) 10-2022-0125809

(51) Int. Cl. H04N 23/51; G03B 13/36; G03B 17/12; H04N 23/54; H04N 23/55; H04N 23/57

(52) U.S. Cl. CPC H04N 23/51; G03B 13/36; G03B 17/12; H04N 23/54; H04N 23/55; H04N 23/57

(57) ABSTRACT

This camera for a vehicle comprises: a first body; a second body coupled to the first body; an actuator arranged inside the first body and the second body; a lens module coupled to the actuator; and a substrate assembly including an image sensor arranged to face the lens module, wherein the actuator comprises: a bobbin to which the lens module is coupled; a first driving unit arranged on the outer surface of the bobbin; and a second driving unit arranged on the outside of the first driving unit.

### TECHNICAL FIELD

The present embodiment relates to a camera for vehicle and a vehicle.

### BACKGROUND ART

Recently, ultra-small camera modules have been developed and are widely used in small electronic products such as smartphones, laptops, and game consoles.

As automobiles become more popular, ultra-small cameras are widely used in vehicles as well as in small electronic products. For example, black box cameras for vehicle protection or objective data on traffic accidents, rear surveillance cameras that allow drivers to monitor the blind spots at the rear of the vehicle through a screen to ensure safety when reversing, and surrounding detection cameras that can monitor the surroundings of the vehicle are provided.

The camera may be provided with a lens, a lens holder that accommodates the lens, an image sensor that converts an image of a subject photographed by the lens into an electric signal, and a printed circuit board on which the image sensor is mounted. The housing forming the outer appearance of the camera is formed with a structure in which the entire area is sealed to prevent internal components from being contaminated by foreign substances containing moisture.

For camera for vehicles, there is a problem of image quality degradation due to changes in the focal distance between the lens and the image sensor under various environmental conditions.

### DETAILED DESCRIPTION OF THE INVENTION

### Technical Subject

The present embodiment is intended to provide a camera module for a vehicle and a vehicle in which an auto focusing (AF) function is implemented.

### Technical Solution

In the present embodiment, a camera for vehicle comprises: a first body; a second body being coupled to the first body; an actuator arranged inside the first body and the second body; a lens module being coupled to the actuator; and a substrate assembly including an image sensor being arranged to face the lens module, wherein the actuator comprises: a bobbin to which the lens module is coupled; a first driving unit being arranged on an outer surface of the bobbin; and a second driving unit being arranged on an outside of the first driving unit.

The actuator includes a cover can for accommodating the bobbin, and the cover can may be integrally formed with the first body by insert injection.

The material of the cover can is metal, and the material of the first body may be plastic.

The substrate assembly includes a first substrate being arranged with the image sensor on an upper surface thereof, and may include an adhesive member being arranged between the first substrate and the actuator.

The adhesive member may include epoxy.

The first driving unit includes a coil, and the second driving unit may include a magnet.

The lens module can be screw-coupled to the bobbin.

A first protruded portion being protruded downward is arranged on a lower surface of the first body, a second protruded portion being protruded upward is arranged on an upper surface of the second body, and the first protruded portion and the second protruded portion can be fusion-bonded.

A groove having a shape being recessed upward more than other regions is arranged on a lower surface of the first body, the groove includes an inclined surface having a shape that becomes closer to the actuator as it goes inward, and one region of the second protruded portion can be arranged within the groove.

According to another embodiment, a camera for vehicle comprises: a first body; a second body being coupled with the first body; an actuator being arranged inside the first body and the second body; a lens module being coupled with the actuator; a substrate assembly including an image sensor being arranged facing the lens module; and a glass being arranged on the first body, wherein the actuator comprises a cover can accommodating a bobbin, and wherein the cover can and the first body are formed to be in direct contact with each other.

### Advantageous Effects

Through the present embodiment, in an external environment where a camera for vehicle is installed, changes in resolution due to temperature changes and changes in target position due to vehicle movement are corresponded through the AF function of the actuator, so there is an advantage in obtaining high-quality photographs.

In addition, since the body forming the outer shape of the camera for vehicle module and the actuator are integrally formed by insert injection, there is an advantage in that the actuator within the body can be firmly fixed.

### BRIEF DESCRIPTION OF DRAWINGS

FIG. 1 is a perspective view of a vehicle according to an embodiment of the present invention.

FIG. 2 is a perspective view illustrating the outer appearance of a camera for vehicle according to an embodiment of the present invention.

FIG. 3 is a drawing illustrating a glass in FIG. 2 in an exploded form.

FIG. 4 is a plan view illustrating a side surface of a camera for vehicle according to an embodiment of the present invention.

FIG. 5 is a cross-sectional view of a camera for vehicle according to an embodiment of the present invention.

FIG. 6 is an exploded perspective view of a camera for vehicle according to an embodiment of the present invention.

FIG. 7 is an exploded perspective view of an actuator according to an embodiment of the present invention.

FIG. 8 is a drawing illustrating a modified embodiment of an actuator according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

The ‘optical axis direction’ used hereinafter is defined as an optical axis direction of the lens. Meanwhile, the ‘optical axis direction’ can correspond to an ‘up-down direction’, a ‘z-axis direction’, and the like.

The ‘auto focus function’ used hereinafter is defined as a function that automatically focuses on a subject by adjusting the distance from an image sensor by moving the lens module in an optical axis direction according to the distance of the subject so that a clear image of the subject can be obtained on an image sensor. Meanwhile, ‘auto focus’ can be used interchangeably with ‘auto focus (AF)’.

The ‘shaking hand correction function’ used hereinafter is defined as a function that moves or tilts the lens module in a direction perpendicular to the optical axis to offset vibration (movement) caused to the image sensor by external force. Meanwhile, ‘shaking hand correction’can be used interchangeably with ‘optical image stabilization (OIS)’.

Hereinafter, the present invention will be described in more detail with reference to the attached drawings.

FIG. 1 is a perspective view of a vehicle according to an embodiment of the present invention.

Referring to FIG. 1, a vehicle 1) according to an embodiment of the present invention may include a body 2, a door 3, glass 4, a headlamp 5, a tail lamp 6, and a camera for vehicle 10.

The above body 2 may be an exterior member of the vehicle 1. The body 2 may have various forms, such as a frame type and a monocoque type. One or more doors 3 may be coupled to a side surface of the body 2. In addition, the glass 4 may be coupled to the front and rear a portion where a pillar is formed of the upper portion of the body 2 and the door 3. The headlamp 5 may be mounted on the front of the lower portion of the body 2. The tail lamp 6 may be mounted on the rear of the lower portion of the body 2.

A camera for vehicle 10 may be installed on a side portion of the body 2 or on a door arranged at the front of one or more of the doors 3. The camera for vehicle 10 may be installed in front of the glass 4 coupled to the door 3. That is, the side mirror in the vehicle 1 of the present embodiment may be rearranged with the camera for vehicle 10.

The above camera for vehicle 10 can photograph images of the rear of both sides of the vehicle. Images photographed by the camera for vehicle 10 can be electrically connected to a display unit (not shown) through an electronic control unit (ECU), and the like. Accordingly, images photographed by the camera for vehicle 10 can be controlled by the electronic control unit (ECU) and played back on the display unit.

An interior space for a driver can be formed inside the body 2. A display unit can be installed inside the body 2. The display unit can output an image photographed by the camera for vehicle 10. The display unit can be installed on a dashboard (not shown) inside the body 2.

The installation form of the camera for vehicle 10 in the vehicle 1 described above is exemplary, and the camera for vehicle 10 can be used for one or more among a front camera, a side camera, a rear camera, and a black box of the vehicle 1.

Hereinafter, a camera for vehicle module according to a present embodiment is described with reference to drawings.

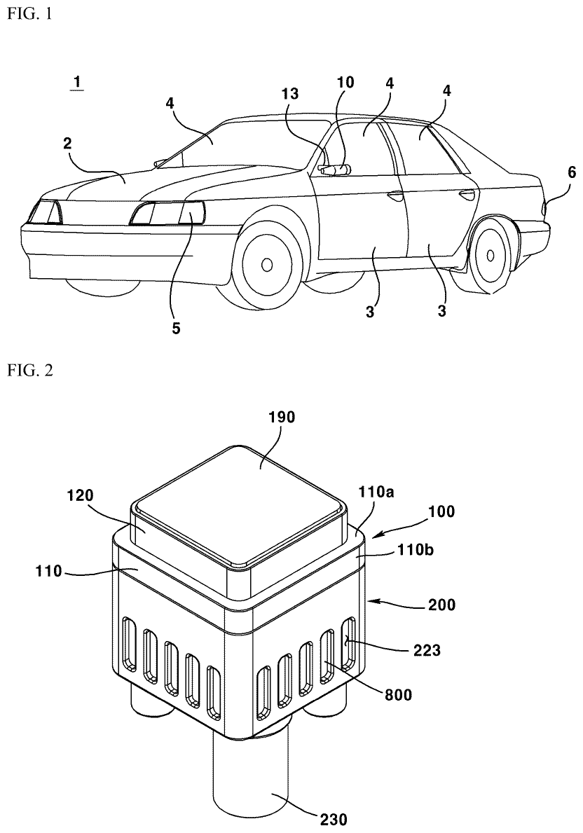

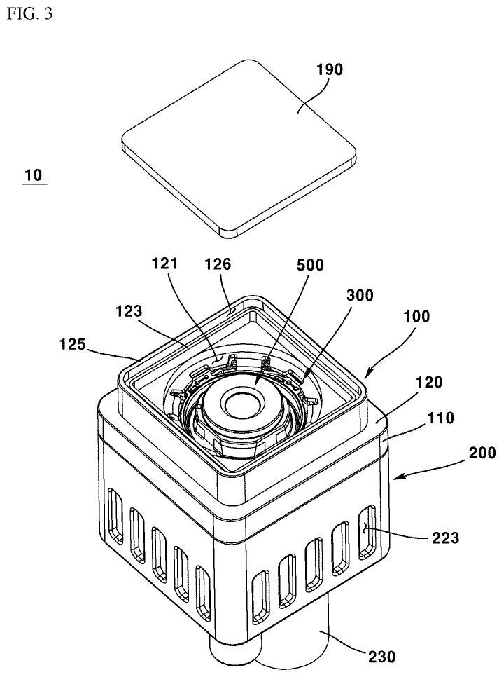

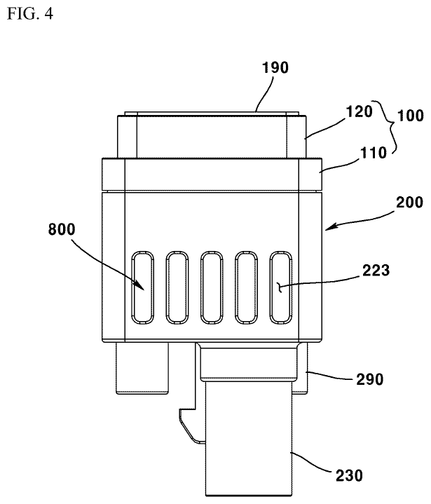

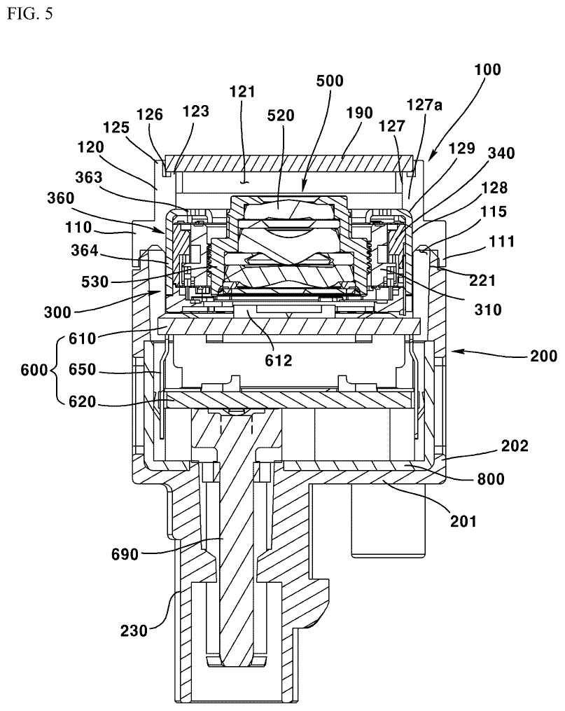

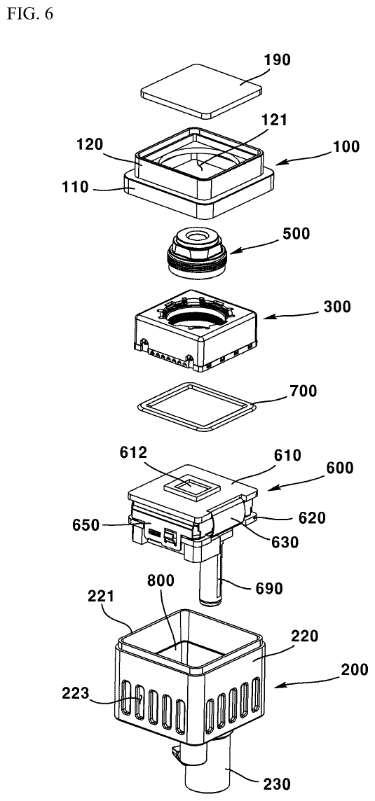

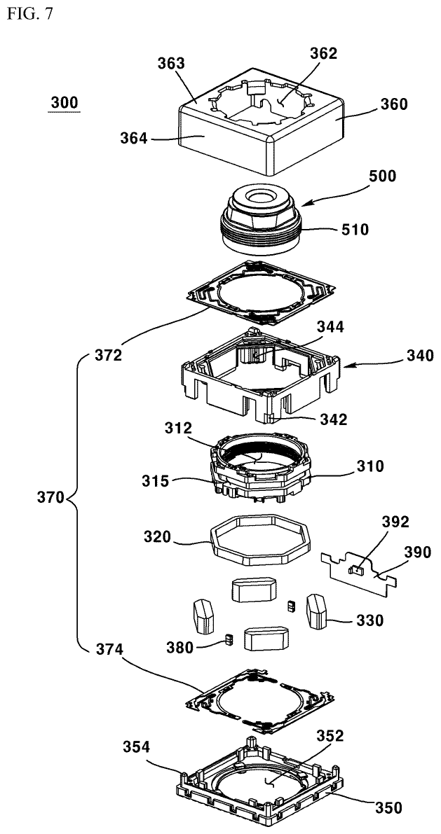

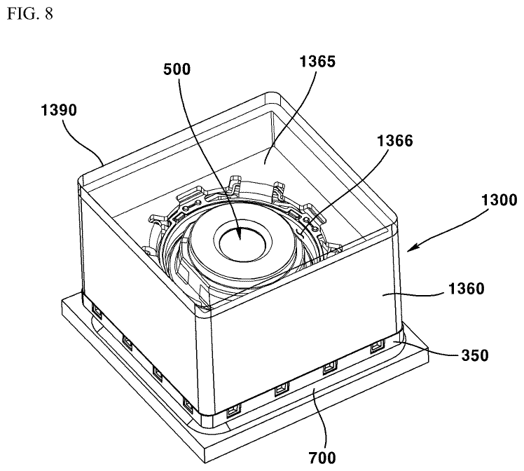

FIG. 2 is a perspective view illustrating the outer appearance of a camera for vehicle according to an embodiment of the present invention; FIG. 3 is a drawing illustrating a glass in FIG. 2 in an exploded form; FIG. 4 is a plan view illustrating a side surface of a camera for vehicle according to an embodiment of the present invention; FIG. 5 is a cross-sectional view of a camera for vehicle according to an embodiment of the present invention; FIG. 6 is an exploded perspective view of a camera for vehicle according to an embodiment of the present invention; and FIG. 7 is an exploded perspective view of an actuator according to an embodiment of the present invention.

Referring to FIGS. 2 to 7, the camera for vehicle module may include a first body 100. The first body 100 may be referred to as one among a front body, an upper housing, and a first housing. The first body 100 may include a first region 110. The first body 100 may include a second region 120. The first region 110 and the second region 120 of the first body 100 may be formed integrally. As a modified embodiment, the first region 110 and the second region 120 may be formed separately.

The first region 110 may be coupled to the second region 120. The first region 110 may be formed integrally with the second region 120. The first region 110 may be formed of a plastic material. The first region 110 may be arranged on a second body 200, which will be described later. The first region 110 may be coupled to the second body 200. The lower end of the first region 110 may be fixed to the second body 200. The first region 110 may be coupled to the second body 200 by any one among ultrasonic welding, laser welding, and thermal welding. As a modified embodiment, the first region 110 may be coupled to the second body 200 by an adhesive.

The first region 110 may be formed in a rectangular shape with an open lower portion. The corners of the first region 110 may be formed to be rounded. The first region 110 may include an upper plate 110a and a side plate 110b being extended downward from the upper plate 110a. The upper plate 110a may be formed in a rectangular shape. The upper plate 110a may be extended outward from a lower end outer circumferential surface of the second region 120. The side plate 110b may be extended downward from the outer edge of the upper plate 110a. The side plate 110b may be provided in plural. The side plate 110b may include four side plates. The side plate 110b may be formed in a square plate shape. The side plate 110b may include a first side plate, a second side plate, a third side plate being arranged at an opposite side of the first side plate, and a fourth side plate being arranged at an opposite side of the second side plate. The side plate 110b may include first to fourth corners being arranged between the first to fourth side plates, respectively. Each of the first to fourth corners may include a round shape at least in portion.

The first region 110 may include a first protruded portion 111 (see FIG. 5). The first protruded portion 111 may be protruded downward from a lower surface of the side plate 110b. The first protruded portion 111 may be coupled to the second body 200. At least a portion of the first protruded portion 111 may be fusion-bonded to the second body 200. At least a portion of the first protruded portion 111 may be coupled to the second body 200 by any one among ultrasonic fusion, laser fusion, and thermal fusion. As a modified embodiment, the first protruded portion 111 may be fixed to the second body 200 by an adhesive. Or, a portion of the first protruded portion 111 may be fusion-bonded to the second body 200, and the remainder may be bonded using an adhesive. The region where the first protruded portion 111 and the second body 200 are bonded may be formed in a region being overlapped horizontally with the actuator 300, which will be described later.

A groove 115 having a shape being recessed upward more than other regions may be formed on a lower surface of the first body 100. The groove 115 may be formed on a lower surface of the first region 110. The groove 115 may be arranged at an inner side of the first protruded portion 111. As illustrated in FIG. 5, the groove 115 may include an inclined surface having a shape in which the distance from the actuator 300 becomes closer with respect to a direction perpendicular to the optical axis as it goes inward. Through the groove 115, the coupling process between the first body 100 and the actuator 300, which will be described later, may be more easily performed.

The first body 100 may include the second region 120. The second region 120 may be formed of a plastic material. The second region 120 may be extended upward from an upper surface of the first region 110. The second region 120 may be formed integrally with the first region 110. As a modified embodiment, the second region 120 may be coupled to the first region 110. In this case, the second region 120 may be fixed to the first region 110 by an adhesive. The second region 120 may accommodate glass 190 at an inside thereof.

The cross-sectional area of the second region 120 may be formed smaller than the cross-sectional area of the first region 110.

A space 121 may be formed inside the first body 100. At least a portion of a lens module 500 and an actuator 300, which will be described later, may be accommodated in the space 121. The space 121 may be opened upward and downward through holes formed on upper and lower surfaces of the first body 100, respectively.

As illustrated in FIG. 5, the space 121 may include a first space being formed by the inner surface 128 of the first region 110 and a second space being formed by the inner surface 127 of the second region 120. The cross-sectional area of the first space may be formed to be larger than the cross-sectional area of the second space. The first space and the second space may be connected to each other. The corner surface 129 connecting the inner surface 128 of the first region 110 and the inner surface 127 of the second region 120 may be formed to be round.

In other words, a protruded portion 127a being protruded inwardly compared to other regions may be formed on the inner surface 128 of the space 121, and it may be understood that the protruded portion 127a is formed at an inner side of the second region 120.

The glass 190 may be arranged on an upper surface of the first body 100. The glass 190 is formed of a transparent material and may be arranged facing the lens module 500, which will be described later, in an optical axis direction. Foreign substances may be prevented from entering the space 121 through the glass 190.

A guide to which the glass 190 is coupled may be arranged on an upper surface of the first body 100. The guide may include a first guide portion 125, a second guide portion 123 being arranged at an inner side of the first guide portion 125, and a guide groove 126 being arranged between the first guide portion 125 and the second guide portion 123. The bottom surface of the guide groove 126 may be an upper surface of the second region 120.

The first guide portion 125 may have a shape being protruded upward from an upper surface of the second region 120 more than the other regions. The inner surface of the first guide portion 125 may be arranged to be overlapped at least a portion of the side surface of the glass 190 in a direction perpendicular to the optical axis direction. The upper surface of the first guide portion 125 may be arranged higher than the upper surface of the second guide portion 123. The upper surface of the glass 190 may be arranged higher than the upper surface of the first guide portion 125.

The second guide portion 123 may have a shape being protruded upward from an upper surface of the second region 120 more than the other regions. The upper surface of the second guide portion 123 may support the lower surface of the glass 190. The upper surface of the second guide portion 123 may be in contact with a lower surface of the glass 190.

The guide groove 126 may be arranged between the first guide portion 125 and the second guide portion 123. When viewed from above, the guide groove 126 may have a groove shape. At least a portion of the guide groove 126 may be covered by the glass 190. An adhesive for bonding with the glass 190 may be arranged in the guide groove 126.

The vehicle camera 10 may include a second body 200. The second body 200 may be referred to as one among a rear body, a lower housing, and a second housing. The second body 200 may be formed in a rectangular shape with an open upper portion. The second body 200 may be formed of a plastic material. The second body 200 may be arranged below the first body 100. The second body 200 may be coupled to the first body 100. The second body 200 may be fusion-bonded to the first body 100. The second body 200 may be coupled to the first body 100 by one among ultrasonic fusion, laser fusion, and thermal fusion. At this time, ultrasonic fusion may mean a process in which the fusion portions of the second body 200 and the first body 100 are fused and integrated by vibrating the first body 100 while applying pressure while the second body 200 is fixed. The second body 200 may form an internal space through coupling with the first body 100.

The second body 200 may include a bottom plate 201. The bottom plate 201 may face the upper plate 110a of the first region 110 of the first body 100. The bottom plate 201 may be spaced apart from the upper plate 110a of the first region 110 of the first body 100 in an optical axis direction. The bottom plate 201 may be parallel to the upper plate 110a of the first region 110 of the first body 100. The bottom plate 201 may be formed in a square shape. At this time, at least a portion of the corner of the bottom plate 201 may include a round shape.

The bottom plate 201 may include a hole through which a connector 690, which will be described later, penetrates. A connector extraction portion 230 may be arranged in the hole. The connector extraction portion 230 may penetrate through the hole. A bottom plate of a shield can 800, which will be described later, may be arranged in the bottom plate 201. The bottom plate of the shield can 800 may be in surface contact with the bottom plate 201. The bottom plate of the shield can 800 may be coupled to the bottom plate 201 by insert injection.

The second body 200 may include the side plate 202. The side plate 202 may be extended from the bottom plate 201. The side plate 202 may be extended from an outer edge of the bottom plate 201. The shield can 800 may be arranged in the side plate 202. The shield can 800 may be in surface contact with an inner surface of the side plate 202. The side plate of the shield can 800 may be coupled to the side plate 202 by insert injection. The upper end of the side plate 202 may be coupled to the first body 100. The outer side surface of the side plate 202 may be arranged on the same plane as the outer side surface of the side plate 110b of the first body 100.

The side plate 202 may include: a first region in which a hole 223 is formed; and a second region being extended from the first region and in which the hole 223 is not formed. The first region of the side plate 202 may be attached to the shield can 800. The second region of the side plate 202 may not be attached to the shield can 800. The inner side surface of the side plate 202 may include a step structure being formed by the first region and the second region. The inner side surface of the first region of the side plate 202 may be arranged outside the inner side surface of the second region of the side plate 202. The inner side surface of the second region of the side plate 202 may be protruded inwardly from the inner side surface of the first region of the side plate 202.

The side plate of the shield can 800 may be arranged in a first region of the side plate 202. A side plate of the shield can 800 may be attached to a first region of the side plate 202. The side plate of the shield can 800 may be attached to a first region of the side plate 202 by direct contact. The coating layer of the shield can 800 may be attached to a first region of the side plate 202. The side plate 202 may include a first side plate, a second side plate, a third side plate being arranged at an opposite side of the first side plate, and a fourth side plate being arranged at an opposite side of the second side plate. The side plate may include a first corner being arranged between the first side plate and the second side plate, a second corner being arranged between the second side plate and the third side plate, a third corner being arranged between the third side plate and the fourth side plate, and a fourth corner being arranged between the fourth side plate and the first side plate. The first to fourth corners of the side plate may include a round shape.

The side plate 202 may include a second protruded portion 221. The second protruded portion 221 may be protruded upwardly from an upper surface of the side plate 202. The second protruded portion 221 may be protruded upwardly from an upper surface of the side plate 202. The second protruded portion 221 may be in contact with the first protruded portion 111 of the first body 100. The second protruded portion 221 may be arranged to be overlapped with the first protruded portion 111 in a direction perpendicular to an optical axis direction. The second protruded portion 221 may be arranged at an inner side of the first protruded portion 111. In this case, the outer side surface of the second protruded portion 221 may be arranged to face the inner side surface of the first protruded portion 111. The outer side surface of the second protruded portion 221 may be in contact with the inner side surface of the first protruded portion 111. At this time, the second protruded portion 221 may be arranged to be spaced apart from the actuator 300, which will be described later. That is, an air gap may be formed between the second protruded portion 221 and the actuator 300. Since the air gap has a function of blocking heat, when the first protruded portion 111 and the second protruded portion 221 are fused or external heat is transmitted toward the actuator 300 through the air gap, thereby minimizing damage and axis change due to heat.

The second protruded portion 221 can be coupled with at least a portion of the first protruded portion 111 of the first body 100. The second protruded portion 221 can be fusion-welded with at least a portion of the first protruded portion 111. At this time, the fusion-welding may mean any one among ultrasonic fusion, laser fusion, and thermal fusion. When the first protruded portion 111 and the second protruded portion 221 are fusion-welded through laser fusion, the laser must be transmitted to fuse the inner surface of the first protruded portion 111 and the outer surface of the second protruded portion 221, so the thickness of the first protruded portion 111 may be smaller than the thickness of the second protruded portion 221.

An outer region of the second protruded portion 221 of the upper surface of the side plate 202 may have a groove shape.

The side plate 202 may include a hole 223. The side plate 202 may be formed with the hole 223. The hole 223 may be formed by penetrating the outer side surface and the inner side surface of the side plate 202. The shield can 800 may be exposed to the outside through the hole 223. The hole 223 may expose at least a portion of the side plate of the shield can 800 to the outside. The holes 223 may be provided in multiple numbers and arranged to be spaced apart from each other.

The second body 200 may include a connector withdrawal portion 230. The connector withdrawal portion 230 may be coupled to the bottom plate 201. The connector withdrawal portion 230 may be arranged in a hole of the bottom plate 201. A connector 690 may be arranged inside the connector withdrawal portion 230. The connector withdrawal portion 230 may be formed of a plastic material.

The camera module for vehicle may include a shield can 800. The shield can 800 may be formed of a metal material. The shield can 800 may include a bottom plate, side plates being extended from the bottom plate, and corners being arranged on a plurality of side plates. The bottom plate, side plates, and corners may be formed integrally.

The bottom plate of the shield can 800 may be in contact with the bottom plate 201 of the second body 200. The side plate of the shield can 800 may be in contact with the side plate 202 of the second body 200. The corner of the shield can 800 may be in contact with the corner of the second body 200. A hole may be formed in the bottom plate of the shield can 800 so that the connector 690 may penetrate through it.

The shield can 800 can be coupled with the second body 200 to be waterproof. Depending on the intended use, the waterproofing can satisfy a waterproof/dustproofing grade of IP52 or higher and can satisfy an IP69K grade when arranged outside a vehicle.

The shield can 800 can be formed integrally through metal forming. That is, the bottom plate, side plate, and corner of the shield can 800 can be formed integrally through metal forming.

The shield can 800 may be fixed to the second body 200 through insert molding. The shield can 800 may be fixed to the second body 200 through insert molding. Insert injection or insert molding may refer to a molding method of integrating a metal member and a plastic member. A portion of the second body 200 may be melted by heat generated during the insert injection process and may be introduced into the pores S generated during the pretreatment process of the shield can 800.

The vehicle camera module may include a substrate assembly 600. The substrate assembly 600 may be arranged within the second body 200. The substrate assembly 600 may be arranged in an internal space formed by the coupling of the first body 100 and the second body 300. At least a portion of the substrate assembly 600 may be arranged within the shield can 800.

The substrate assembly 600 may include a first substrate 610. The first substrate 610 may include a printed circuit board. The first substrate 610 may include a rigid printed circuit board. An image sensor 612 may be arranged in the first substrate 610. At this time, the first substrate 610 may be referred to as a sensor substrate. The first substrate 610 may include a first surface facing the first body 100 and a second surface being arranged at an opposite side of the first surface. The image sensor 612 may be arranged on the first surface of the first substrate 610. The first substrate 610 may be coupled with an actuator 300, which will be described later. The first substrate 610 can be coupled to an actuator 300 through an adhesive member 700.

The substrate assembly 600 may include a second substrate 620. The second substrate 620 may include a printed circuit board. The second substrate 620 may include a rigid printed circuit board. The second substrate 620 may be arranged below the first substrate 610. The second substrate 620 may be spaced apart from the first substrate 610. The second substrate 620 may be spaced apart from the first substrate 610 in an optical axis direction. The second substrate 620 may supply power to the first substrate 610. The second substrate 620 may be arranged parallel to the first substrate 610. The second substrate 620 may be electrically connected to the connector 690. The second substrate 620 may include a first surface facing the first substrate 610 and a second surface being arranged at an opposite side of the first surface. The connector 690 may be arranged in a second surface of the second substrate 620.

The substrate assembly 600 may include a third substrate 630. The third substrate 630 may include a flexible printed circuit board (FPCB). The third substrate 630 may electrically connect the first substrate 610 and the second substrate 620. One end of the third substrate 630 may be connected to the first substrate 610, and the other end of the third substrate 630 may be connected to the second substrate 620. The third substrate 630 may have elasticity.

The substrate assembly 600 may include a spacer 650. The spacer 650 may be referred to as an electromagnetic shielding member. The spacer 650 may block electromagnetic interference (EMI) or electromagnetic waves. The spacer 650 may perform a function of spacing apart between the pluralities of substrates. The spacer 650 may be formed of a metal material.

The spacer 650 may include a protrusion and a hole for supporting the first substrate 610 or the second substrate 620. A protrusion being coupled to the hole of the spacer 650 may be formed on a side surface of the first substrate 610 or a side surface of the second substrate 620. The protrusion of the spacer 650 may support a surface of the first substrate 610 or a surface of the second substrate 620.

The spacer 650 may be arranged inside the shield can 800. The spacer 650 may be spaced apart from the shield can 800. The spacer 650 may be spaced apart from the bottom plate of the shield can 800 in an optical axis direction. The spacer 650 may be spaced apart from the side plate of the shield can 800 in a direction perpendicular to the optical axis direction. The spacer 650 may be formed of a metal material. The thickness of the spacer 650 may be thinner than the thickness of the side plate of the shield can 800. The spacer 650 may face the side plate of the shield can 800.

The substrate assembly 600 may include a connector 690. The connector 690 may be arranged on a second surface of the second substrate 620. The connector 690 may be fixed to a second surface of the second substrate 620. The connector 690 may be electrically connected to the second substrate 620.

The vehicle camera module may include a lens module 500. At least a portion of the lens module 500 may be coupled to the actuator 300. At least a portion of the lens module 500 may be protruded more upward than an upper surface of the actuator 300. The lens module 500 may include a lens barrel 530 (see FIG. 4) and at least one lens 520 being disposed within the lens barrel 530.

Inside the lens barrel 530, a space whose upper surface and lower surfaces are opened is included, and the lens 520 can be arranged in the space. A first screw portion 510 can be formed on an outer circumferential surface of the lens barrel 530. The first screw portion 510 includes a screw thread or a screw groove, and the lens barrel 530 can be screw-coupled to the actuator 300 through the first screw portion 510.

The lens 520 may be arranged within the lens barrel 530. The lens 520 may be provided in multiple numbers and arranged along an optical axis direction. The lens 520 may be aligned with the image sensor 612. The lens 520 may be arranged to face the image sensor 612 in an optical axis direction. The lens 520 may be arranged to face the glass 190 in an optical axis direction. The lens 520 may be moved in an optical axis direction by the actuator 300.

The vehicle camera module may include an actuator 300. The actuator 300 may be an auto focusing (AF) actuator that applies a voice coil motor to move the lens module 500 in an optical axis direction, but is not limited thereto, and an embodiment may be applied to an optical image stabilization (OIS) type, unlike the one illustrated.

As illustrated in FIG. 7, the actuator 300 may include a bobbin 310, a coil 320, a magnet 330, a housing 340, a cover can 360, a base 350, and an elastic member 370. In addition, the actuator 300 may further include a position sensor 392, a circuit board 390, and a sensing magnet 380 for AF feedback driving.

The bobbin 310 is formed in a cylindrical shape with open upper and lower surfaces, and a hollow space 312 may be formed in the center of the bobbin 310 to which the lens module 500 is coupled. A screw thread or screw groove may be formed on an inner surface of the hollow space 312 so that the lens barrel 530 may be screw-coupled through the first screw portion 510. Accordingly, the lens module 500 may be screw-coupled to the bobbin 310.

A coil coupling portion 315 to which the coil 320 is coupled is formed on an outer circumferential surface of the bobbin 310, and the coil coupling portion 315 may have a groove shape being recessed inward from an outer circumferential surface of the bobbin 310.

The coil 320 may be arranged on an outer surface of the bobbin 310. The coil 320 may be coupled to the coil coupling portion 315. The coil 320 may have a ring-shaped cross-section. The coil 320 may be electrically connected to the substrate assembly 600. The coil 320 may be electrically connected to the first substrate 610. The coil 320 may be referred to as a first driving unit.

The housing 340 may be arranged at an outside of the bobbin 310. The housing 340 may have a hexahedral shape with open upper and lower surfaces. A coupling groove 342 having a shape being recessed upward more than other regions may be formed on a lower surface of the housing 340. The coupling groove 342 may be formed on an outer surface of the four corner regions of the housing 340. The housing 340 may be coupled to the base 350 through the coupling groove 342.

A magnet coupling portion 344 to which the magnet 330 is coupled may be formed on an inner surface of the housing 340. The magnet coupling portion 344 may be formed in a corner region of the inner surface of the housing 340. The magnet coupling portion 344 may have a groove shape. The magnet coupling portions 344 may be provided in multiple numbers and arranged to be spaced apart from one another.

The magnet 330 may be arranged at an outside of the coil 320. The magnet 330 may be coupled to the housing 340. The magnet 330 may be coupled to the magnet coupling portion 344. The magnet 330 is provided in four pieces, and the four magnets 330 may be respectively arranged in corner regions on an inner surface of the housing 340. Therefore, by the electromagnetic interaction between the coil 320 and the magnet 330, the bobbin 310 may move in an optical axis direction together with the lens module 500. The magnet 330 may be referred to as a second driving unit.

Meanwhile, in the present embodiment, the first driving unit is a coil and the second driving unit is a magnet, but this is not limited to the present invention, and a magnet may be arranged on an outer surface of the bobbin 310 and a coil may be arranged facing the magnet of the housing 340.

The base 350 can support a lower surface of the housing 340. The base 350 can be arranged below the housing 340 and the bobbin 310. The base 350 can include a hole 352 so that the lens module 500 is exposed downward. The lens module 500 can be arranged to face the image sensor 612 through the hole 352.

The base 350 may have a rectangular cross-sectional shape. A protrusion 354 may be formed on an upper surface of the base 350 facing the coupling groove 342 of the housing 340. The protrusion 354 may have a shape being protruded more upward from an upper surface of the base 350 than other regions. The protrusion 354 may be respectively arranged at the corner regions of the base 350. When the base 350 and the housing 340 are coupled, the protrusions 354 may be coupled to the coupling groove 342.

The elastic member 370 can elastically support the movement of the bobbin 310. The elastic member 370 can include an upper elastic member 372 being coupled to an upper surface of the bobbin 310 and the housing 340, and a lower elastic member 374 being coupled to a lower surface of the bobbin 310 and the housing 340.

The upper elastic member 372 may include an inner elastic portion being coupled to an upper surface of the bobbin 310, an outer elastic portion being coupled to an upper surface of the housing 340, and a connecting elastic part connecting the inner elastic portion and the outer elastic portion. A protrusion for coupling with an upper elastic member 372 may be formed on an upper surface of the bobbin 310 or an upper surface of the housing 340.

The lower elastic member 374 may include an inner elastic portion being coupled to a lower surface of the bobbin 310, an outer elastic portion being coupled to a lower surface of the housing 340, and a connecting elastic portion connecting an inner elastic portion and an outer elastic portion. A protrusion for coupling with the lower elastic member 374 may be formed on a lower surface of the bobbin 310 or the lower surface of the housing 340.

The cover can 360 may be arranged at an outside of the housing 340. The cover can 360 may be formed of a non-magnetic metal material. The cover can 360 may be formed in a box shape having an open bottom and including an upper plate 363 and a side plate 364. A hole 362 may be formed in an upper plate 363 of the cover can 360 so that the lens 500 may penetrate through it. A corner region connecting the upper plate 363 and the side plate 364 may be formed to be round. The housing 340, the bobbin 310, and at least a portion of the lens module 500 may be arranged within the cover can 360. A space in which components within the actuator 300 can be accommodated can be formed by coupling the cover can 360 and the base 350. A lower end of the cover can 360 can be coupled with the base 350.

The sensing magnet 380 may be arranged on an outer surface of the bobbin 310. A groove-shaped coupling region may be formed on an outer surface of the bobbin 310 so that the sensing magnet 380 may be coupled. The sensing magnet 380 may be provided in multiple numbers and may be arranged to face one another about the hollow 312 of the bobbin 310.

The circuit board 390 may be arranged on an inner surface of the housing 340 or an inner surface of the cover can 360. The circuit board 390 may be electrically connected to the board assembly 600. A position sensor 392 may be arranged on a surface of the circuit board 390 facing the sensing magnet 380. Accordingly, the position sensor 392 may detect the magnetic field of the sensing magnet 380 being changed due to movement of the bobbin 310, thereby detecting the position of the bobbin 310. The actuator 300 arranged to adjust the optical axis of the lens 520 may be driven by detecting the temperature through a temperature sensor (not shown) separately arranged in the substrate 390 and driving the actuator 300, or a temperature sensor (not shown) may be arranged on some substrates in the substrate assembly 600 to detect the temperature to drive the actuator 300. Or, the actuator 300 may be driven by including a function for adjusting the resolution in the image sensor 610.

The actuator 300 and the substrate assembly 600 may be coupled to each other through an adhesive member 700. The adhesive member 700 may include epoxy. The adhesive member 700 may be disposed between the lower surface of the actuator 300 and the upper surface of the first substrate 610. The adhesive member 700 may be disposed between a lower surface of the base 350 and an upper surface of the first substrate 610. By adjusting the thickness of the adhesive member 700, the distance between the image sensor 612 and the lens 520 within the lens module 500 may be adjusted. That is, the active alignment (AA) distance for lens focusing may be adjusted.

Meanwhile, the actuator 300 may be formed integrally with the first body 100 by insert molding. The cover can 360 of the actuator 300 may be coupled with the first body 100 by insert molding. Accordingly, since the cover can 360 made of metal and the first body 100 made of plastic are coupled as one body, there is an advantage in that the actuator 300 may be firmly fixed within the first body 100. That is, since the lens module 500 is arranged inside the actuator 300, axial alignment may be a problem when the actuator 300 and the first body 100 are coupled. To prevent this, the cover can 360 of the actuator 300 can be fixed as one body by insert-molding the first body 100, thereby reducing the points of axial alignment and facilitating axial alignment. At this time, a portion of the protruded portion 127a of the first body 100 can be arranged on an upper surface of the cover can 360.

When the actuator 300 and the first body 100 are coupled, the side plate 364 of the cover can 360 can be coupled to the inner surface 128 of the space 121 within the first body 100. The upper plate 363 of the cover can 360 can be coupled to a lower surface of the protruded portion 127a of the space 121 within the first body 100. The corner region connecting the side plate 364 and the upper plate 363 of the cover can 360 can be coupled to a corner surface 129 connecting the inner surface of the protruded portion 127a and the inner surface of the space 121.

The cover can 360 and the first body 100 can be coupled to be waterproof. To this end, the surface of the cover can 360 being coupled with the first body 100 can be surface treated.

According to the structure described above, in the external environment where the vehicle camera is installed, changes in resolution due to temperature changes and changes in target position due to movement of the vehicle are corresponded through the AF function of the actuator, so there is an advantage in obtaining high-quality photographs.

In addition, since the body forming the outer shape of the vehicle camera module and the actuator are integrally formed by insert injection, there is an advantage in that the actuator within the body can be firmly fixed.

FIG. 8 is a drawing illustrating a modified embodiment of an actuator according to an embodiment of the present invention.

In the present modified embodiment, there is a difference in the coupling region of the glass from the above-described embodiment. Therefore, components having the same structure and function will be described by assigning the same drawing reference numerals.

Referring to FIG. 8, the glass 1390 may be modified embodiment on the actuator 1300. The glass 1390 may be arranged on an upper surface of the cover can 1360. In this case, the lens module 500 may be accommodated in a space within the cover can 1360.

In the space inside the cover can 1360, a cover plate 1365 being protruded inwardly from an inner surface of a side plate forming a side surface of the cover can 1360 may be arranged. A hole 1366 may be formed in the center of the cover plate 1365 so that the lens module 500 may penetrate therethrough. The lens module 500 may be arranged, at least partially, to be protruded upwardly from the cover plate 1365 by penetrating through the hole 1366.

Accordingly, the actuator 1300 can be integrally coupled to an inner surface 128 of the space 111 in the first body 100 see FIG. 4 by insert injection. The side plate of the cover can 1360 of the actuator 1300 can be integrally coupled to an inner surface 128 by insert injection. Therefore, in the present modified embodiment, the protruded portion 127 of the space 111 in the first body 100 of the above-described embodiment can be omitted.

According to the above structure, there is an advantage in that external foreign substances can be prevented from being introduced into the space within the actuator 1300 through the glass 1390.

Meanwhile, an infrared blocking film for infrared blocking may be attached to a surface of the glass 1390, or an infrared blocking agent may be applied.

Although the embodiments of the present invention have been described with reference to the attached drawings, those skilled in the art will understand that the present invention can be implemented in other specific forms without changing the technical idea or essential features thereof. Therefore, it should be understood that the embodiments described above are exemplary in all respects and not restrictive.

1-10. (canceled)

11. A camera module comprising:
a first body;
a second body coupled to the first body;
an actuator arranged inside the first body and the second body;
a lens module coupled to the actuator; and
a substrate assembly including an image sensor arranged to face the lens module,
wherein the actuator comprises:
a bobbin to which the lens module is coupled;
a first driving unit arranged on an outer surface of the bobbin; and
a second driving unit arranged on an outside of the first driving unit,
wherein the actuator includes a cover can for accommodating the bobbin, and
wherein the cover can is integrally formed with the first body by insert injection.

12. The camera module according to claim 11, wherein the actuator comprises:
a housing arranged on an outside of the bobbin and to which the second driving unit is coupled;
a base that supports a lower surface of the housing and is positioned below the bobbin; and
an elastic member connected to the bobbin and the housing.

13. The camera module according to claim 11, wherein a material of the cover can is metal, and a material of the first body is plastic.

14. The camera module according to claim 11, wherein the substrate assembly includes a first substrate arranged with the image sensor on an upper surface thereof, and
wherein an adhesive member arranged between the first substrate and the actuator is included.

15. The camera module according to claim 14, wherein the adhesive member includes epoxy.

16. The camera module according to claim 11, wherein the first driving unit includes a coil, and
wherein the second driving unit includes a magnet.

17. The camera module according to claim 11, wherein the lens module is screw-coupled to the bobbin.

18. The camera module according to claim 11, wherein a first protruded portion protruded downward is arranged on a lower surface of the first body,
wherein a second protruded portion protruded upward is arranged on an upper surface of the second body, and
wherein the first protruded portion and the second protruded portion are fusion-bonded.

19. The camera module according to claim 18, wherein a groove having a shape recessed upward more than other regions is arranged on a lower surface of the first body,
wherein the groove includes an inclined surface having a shape that becomes closer to the actuator as it goes inward, and
wherein one region of the second protruded portion is arranged within the groove.

20. The camera module according to claim 18, comprising a glass disposed on the first body.

21. The camera module according to claim 11, comprising a glass disposed on the first body.

22. The camera module according to claim 11, comprising a shield can arranged on an inside of the second body,
wherein the second body includes a hole for exposing the shield can to an outside.

23. The camera module according to claim 14, wherein the first substrate is electrically connected to the first driving unit.

24. The camera module according to claim 11, wherein the cover can includes a side plate and a top plate,
wherein the first body includes a space in which at least a part of the actuator is arranged and a protrusion protruding inwardly from an inner surface of the space,
wherein the side plate of the cover can is coupled with the inner surface of the space, and
wherein the top plate of the cover can is coupled with a lower surface of the protrusion.

25. The camera module according to claim 24, wherein a corner surface connecting the inner surface of the space and the lower surface of the protrusion has a rounded shape.

26. A camera module comprising:
a first body;
a second body coupled with the first body;
an actuator arranged inside the first body and the second body;
a lens module coupled with the actuator;
a substrate assembly including an image sensor arranged facing the lens module; and
a glass arranged on the first body,
wherein the actuator comprises a cover can accommodating a bobbin, and
wherein the cover can and the first body are formed to be in direct contact with each other.

27. The camera module according to claim 26, wherein a material of the cover can is metal, and a material of the first body is plastic.

28. The camera module according to claim 26, wherein the substrate assembly includes a first substrate arranged with the image sensor on an upper surface thereof, and
wherein an adhesive member is arranged between the first substrate and the actuator.

29. The camera module according to claim 26, wherein the lens module is screw-coupled to the bobbin.

30. The camera module according to claim 26, comprising a glass disposed on the first body.
